(19) United States
(12) Patent Application Publication
(10) Pub. No.: US 2016/0369409 A1
(43) Pub. Date: Dec. 22, 2016

(54) PHOTOELECTROCHEMICAL REACTION SYSTEM

(71) Applicant: Kabushiki Kaisha Toshiba, Minato-ku (JP)

(72) Inventors: Yuki KUDO, Yokohama (JP); Satoshi MIKOSHIBA, Yamato (JP); Akihiko ONO, Kita (JP); Jun TAMURA, Yokohama (JP); Eishi TSUTSUMI, Kawasaki (JP); Ryota KITAGAWA, Setagaya (JP); Chingchun HUANG, Ota (JP); Yoshitsune SUGANO, Kawasaki (JP)

(73) Assignee: Kabushiki Kaisha Toshiba, Minato-ku (JP)

(21) Appl. No.: 15/249,988

(22) Filed: Aug. 29, 2016

Related U.S. Application Data
(63) Continuation of application No. PCT/JP2015/001238, filed on Mar. 6, 2015.

(30) Foreign Application Priority Data
Mar. 24, 2014 (JP) 2014-060062

(51) Int. Cl. C25B 1/00; H01G 9/20; C25B 15/08; C25B 9/00; C25B 3/04; C25B 1/04

(52) U.S. Cl. CPC C25B 1/003; C25B 3/04; C25B 1/04; C25B 15/08; C25B 9/00; H01G 9/20

(57) ABSTRACT

A photoelectrochemical reaction system of an embodiment includes: a CO₂ generation unit, a CO₂ reduction unit, and a CO₂ supply unit supplying gas containing CO₂ generated in the CO₂ generation unit into the CO₂ reduction unit. The CO₂ reduction unit includes: a stack 3 including an oxidization electrode layer 11 oxidizing H₂O, a reduction electrode layer 21 reducing CO₂, and a photovoltaic layer 31 provided between the electrode layers 11, 21; an electrolytic solution tank 2 storing a first electrolytic solution 4 in which the oxidization electrode layer 11 is immersed and a second electrolytic solution 5 in which the reduction electrode layer 21 is immersed; and an ion migration pathway 6 allowing ions to migrate between the first electrolytic solution 4 and the second electrolytic solution 5. The gas containing CO₂ generated in the CO₂ generation unit is supplied into the second electrolytic solution 5 by a gas supply pipe 51 of the CO₂ supply unit.

### CROSS-REFERENCE TO RELATED APPLICATIONS

This application is a continuation of prior International Application No. PCT/JP2015/001238 filed on Mar. 6, 2015, which is based upon and claims the benefit of priority from Japanese Patent Application No. 2014-060062 filed on Mar. 24, 2014; the entire contents of all of which are incorporated herein by reference.

### FIELD

Embodiments described herein relate generally to a photoelectrochemical reaction system.

### BACKGROUND

From the viewpoint of an energy problem and an environmental problem, a technology of efficiently reducing CO₂ using light energy like plants is required. The plants use a system, called a Z-scheme, which is excited at two stages by light energy. Namely, the plants obtain electrons from water (H₂O) by light energy, and synthesize cellulose and saccharide by reducing carbon dioxide (CO₂) using the electrons. In an artificial photoelectrochemical reaction, low decomposition efficiency is obtained in a technology of decomposing CO₂ without using a sacrificial reagent.

As an artificial photoelectrochemical reaction device, a two-electrode type device is known in which an electrode having a reduction electrode reducing carbon dioxide (CO₂) and an oxidization electrode oxidizing water (H₂O) are included, and these electrodes are immersed in water where CO₂ is dissolved. The oxidization electrode oxidizes H₂O by light energy to obtain oxygen (½O₂) and potential. The reduction electrode reduces CO₂ by receiving the potential from the oxidization electrode so as to generate a chemical substance (chemical energy) such as formic acid (HCOOH). In the two-electrode type device, a reduction potential of CO₂ is obtained by two-stage excitation similarly to the Z-scheme of the plants, and therefore, conversion efficiency from the sunlight to the chemical energy is very low, namely, about 0.4%.

As a photoelectrochemical reaction device splitting water (H₂O) by light energy to obtain oxygen (O₂) and hydrogen (H₂), use of a stack (silicon solar cell or the like) in which a photovoltaic layer is sandwiched between a pair of electrodes is under consideration. For example, an electrode on a light irradiation side oxidizes water (2H₂O) by light energy to obtain oxygen (O₂) and hydrogen ions (4H⁺) The electrode on the opposite side obtains hydrogen (2H₂) as a chemical substance using the hydrogen ions (4H⁺) generated by the electrode on the light irradiation side and the potential (e⁻) generated in the photovoltaic layer. The conversion efficiency from the sunlight to the chemical energy (O₂ and H₂) is as high as about 2.5%.

However, CO₂ decomposition with high efficiency by light energy has not been realized in the conventional photoelectrochemical reaction device. In order to enhance the efficiency of the reduction reaction of CO₂, it is necessary to promote migration of the hydrogen ions or the like generated by the oxidation reaction of H₂O to the opposite electrode, which is not into consideration in the conventional device. In order to enhance the practicality of the photoelectrochemical reaction device decomposing CO₂, the transfer efficiency of gas containing CO₂ from a device exhausting CO₂ to the photoelectrochemical reaction device needs to be considered but is not taken into consideration in the conventional device. If transfer of the gas containing CO₂ requires energy, the energy efficiency as a photoelectrochemical reaction system decreases.

### BRIEF DESCRIPTION OF THE DRAWINGS

FIG. 1 is a configuration diagram of a photoelectrochemical reaction system according to a first embodiment.

FIG. 2 is a sectional view illustrating a first example of the photoelectrochemical module used in the photoelectrochemical reaction system illustrated in FIG. 1.

FIG. 3A is a sectional view illustrating a second example of the photoelectrochemical module used in the photoelectrochemical reaction system illustrated in FIG. 1.

FIG. 3B is a plan view illustrating a photovoltaic cell used in the photoelectrochemical module in the second example.

FIG. 4 is a sectional view illustrating a third example of the photoelectrochemical module used in the photoelectrochemical reaction system illustrated in FIG. 1.

FIG. 5 is a sectional view illustrating a first example of a photovoltaic cell used in the photoelectrochemical module illustrated in FIG. 2 or FIG. 4.

FIG. 6 is a sectional view illustrating a second example of a photovoltaic cell used in the photoelectrochemical module illustrated in FIG. 2 or FIG. 4.

FIG. 7 is a view for explaining the operation of the photovoltaic cell illustrated in FIG. 5.

FIG. 8 is a configuration diagram of a photoelectrochemical reaction system according to a second embodiment.

FIG. 9 is a configuration diagram of a photoelectrochemical reaction system according to a third embodiment.

### DETAILED DESCRIPTION

According to one embodiment, there is provided a photoelectrochemical reaction system including a CO₂ generation unit generating gas containing carbon dioxide, a CO₂ reduction unit, and a CO₂ supply unit. The CO₂ reduction unit includes: a stack including an oxidization electrode layer oxidizing water, a reduction electrode layer reducing carbon dioxide, and a photovoltaic layer provided between the oxidization electrode layer and the reduction electrode layer and performing a charge separation by light energy; an electrolytic solution tank storing a first electrolytic solution in which the oxidization electrode layer is immersed and a second electrolytic solution in which the reduction electrode layer is immersed; and an ion migration pathway allowing ions to migrate between the first electrolytic solution and the second electrolytic solution. The CO₂ supply unit includes a gas supply pipe supplying the gas containing carbon dioxide generated in the CO₂ generation unit into the second electrolytic solution.

Hereinafter, a photoelectrochemical reaction system of an embodiment will be described referring to the drawings.

### First Embodiment

FIG. 1 is a configuration diagram of a photoelectrochemical reaction system according to a first embodiment. A photoelectrochemical reaction system 100 of the first embodiment includes a CO₂ generation unit 101, an impurity removal unit 102, a CO₂ supply unit 103, a CO₂ reduction unit 104, and a product collection unit 105. As a representative example of the CO₂ generation unit 101, a power plant can be exemplified. However, the CO₂ generation unit 101 is not limited to this but may be an iron factory, a chemical factory, a disposal center or the like.

Gas containing CO₂ generated in the CO₂ generation unit 101, for example, exhaust gas exhausted from the power plant, iron factory, chemical factory, disposal center or the like is sent to the impurity removal unit 102. In the impurity removal unit 102, a CO₂ gas is separated, for example, by removing impurities such as sulfur oxide and the like from, for example, the gas (exhaust gas) containing CO₂. As the impurity removal unit 102, various dry-type or wet-type gas processing apparatus (sulfur oxide absorption apparatus or the like) is employed. Depending on the kind of the CO₂ generation unit 101, conditions or the like, the generated gas containing CO₂ is sent directly to the CO₂ supply unit 103 without passing through the impurity removal unit 102 in some cases.

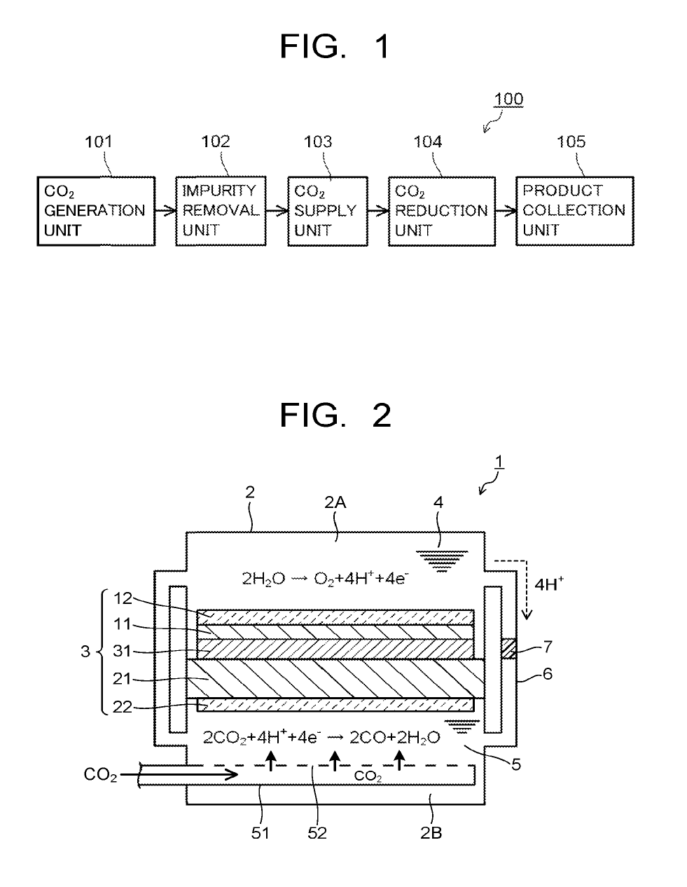

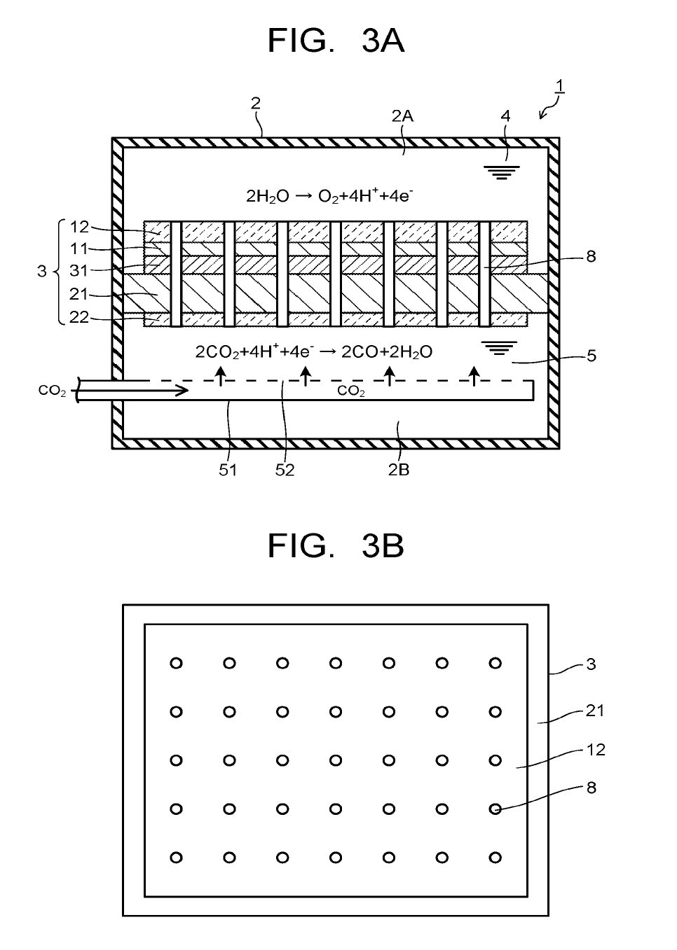

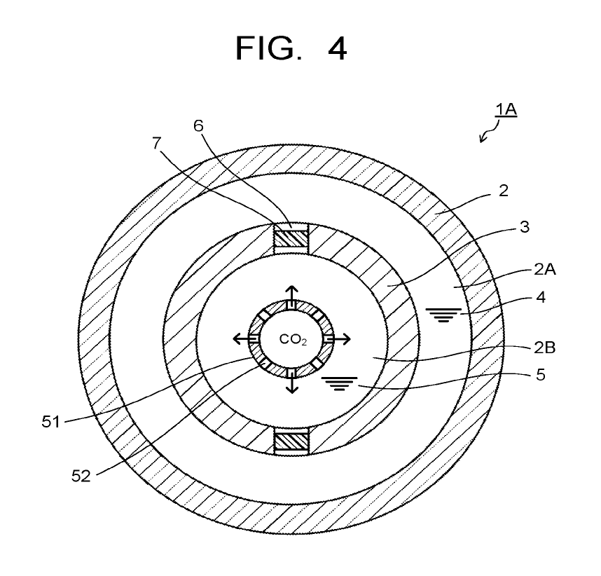

The CO₂ gas from which the impurities have been removed in the impurity removal unit 102 is sent by the CO₂ supply unit 103 to the CO₂ reduction unit 104. The CO₂ supply unit 103 has, as will be described later, a gas supply pipe that supplies the CO₂ gas into an electrolytic solution in the CO₂ reduction unit 104. The CO₂ reduction unit 104 includes a photoelectrochemical module 1 illustrated, for example, in FIG. 2 to FIG. 4. FIG. 2 is a sectional view illustrating a first example of the photoelectrochemical module 1. FIG. 3A is a sectional view illustrating a second example of the photoelectrochemical module 1, and FIG. 3B is a plan view illustrating a photovoltaic cell used in the photoelectrochemical module 1 in the second example. FIG. 4 is a sectional view illustrating a third example of the photoelectrochemical module 1.

The photoelectrochemical module 1 illustrated in FIG. 2 includes a stack 3 arranged in an electrolytic solution tank 2. The stack 3 includes a first electrode layer 11, a second electrode layer 21, a photovoltaic layer 31 provided between the electrode layers 11, 21, a first catalyst layer 12 provided on the first electrode layer 11, and a second catalyst layer 22 provided on the second electrode layer 21. The constitutional layers of the stack 3 will be described later. The electrolytic solution tank 2 is divided into two chambers by the stack 3. The electrolytic solution tank 2 is divided into a first liquid chamber 2A where the first electrode layer 11 and the first catalyst layer 12 are arranged, and a second liquid chamber 2B where the second electrode layer 21 and the second catalyst layer 22 are arranged. A first electrolytic solution 4 is filled in the first liquid chamber 2A, and a second electrolytic solution 5 is filled in the second liquid chamber 2B. The electrolytic solution tank 2 is provided with a not-illustrated window member having a light-transmission property to apply light from the outside to the stack 3.

The first liquid chamber 2A and the second liquid chamber 2B are connected to each other via an electrolytic solution flow path 6 provided lateral to the electrolytic solution tank 2 as an ion migration pathway. In a part of the inside of the electrolytic solution flow path 6, an ion exchange membrane 7 is filled. The electrolytic solution flow path 6 equipped with the ion exchange membrane 7 allows specific ions (for example, H⁺) to migrate between the first electrolytic solution 4 and the second electrolytic solution 5 while separating the first electrolytic solution 4 filled in the first liquid chamber 2A and the second electrolytic solution 5 filled in the second liquid chamber 2B. As the ion exchange membrane 7, for example, a cation exchange membrane such as Nafion or Flemion or an anion exchange membrane such as Neocepter or SELEMION is used. In the electrolytic solution flow path 6, a glass filter, agar or the like may be filled. When the first electrolytic solution 4 and the second electrolytic solution 5 are the same solution, the ion exchange membrane 7 does not have to be provided. To efficiently migrate the ions, a plurality of (two or more) electrolytic solution flow paths 6 may be provided in the electrolytic solution tank 2. The dimension of each member of the photoelectrochemical module illustrated in FIG. 2 does not indicate its actual size. To facilitate the movement of the ions, the cross-sectional area of the electrolytic solution flow path 6 may be larger than that of the stack 3.

The ion migration pathway is not limited to the electrolytic solution flow path 6 provided lateral to the electrolytic solution tank 2. The ion migration pathway between the first electrolytic solution 4 and the second electrolytic solution 5 may be composed of a plurality of pores (through holes) 8 provided in the stack 3. The pore 8 only needs to have a size through which the ions can move. For example, the lower limit of the diameter (circle-equivalent diameter) of the pore 8 is preferably 0.3 nm or more. The circle equivalent diameter is defined by ((4×area)/{pi})^{1/2}. The shape of the pore 8 is not limited to a circle but may be an ellipse, a triangle, or a square. The arrangement of the pores 8 is not limited to a square lattice shape but may be a triangle lattice shape, random or the like. The ion migration pathway is not limited to the pores 8 but may be a long hole, or a slit.

In the photoelectrochemical module illustrated in FIG. 3, a not-illustrated ion exchange membrane is filled in the pores 8 in order to separate the first electrolytic solution 4 filled in the first liquid chamber 2A from the second electrolytic solution 5 filled in the second liquid chamber 2B. Concrete examples of the ion exchange membrane 7 are as described above. In the pores 8, a glass filter, agar or the like may be filled in place of the ion exchange membrane 7. When the first electrolytic solution 4 and the second electrolytic solution 5 are the same solution, the ion exchange membrane does not have to be provided. The shape and the formation pitch of the pores 8 as the ion migration pathway are preferably set in consideration of the migratory property of ions and the area of the electrode layer (and the catalyst layer) reduced due to the provision of the pores 8. Concretely, the ratio of the area of the pores 8 to the area of the electrode layer is preferably 40% or less, and more preferably, 10% or less.

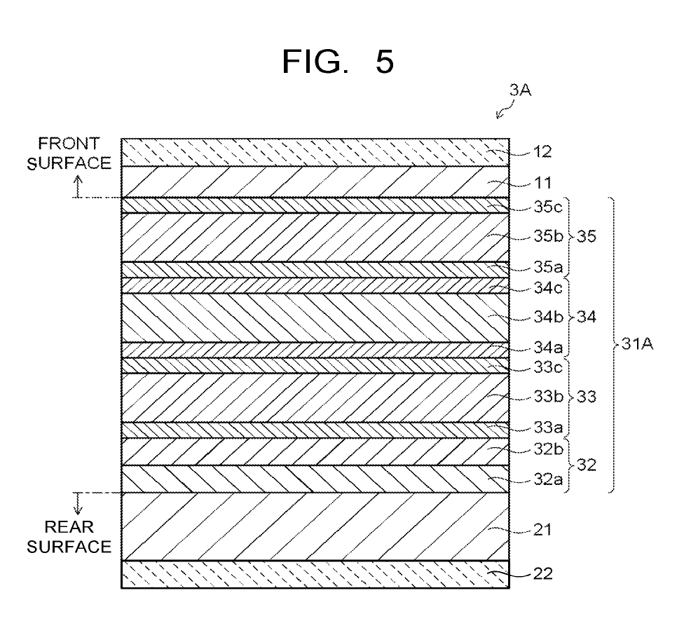

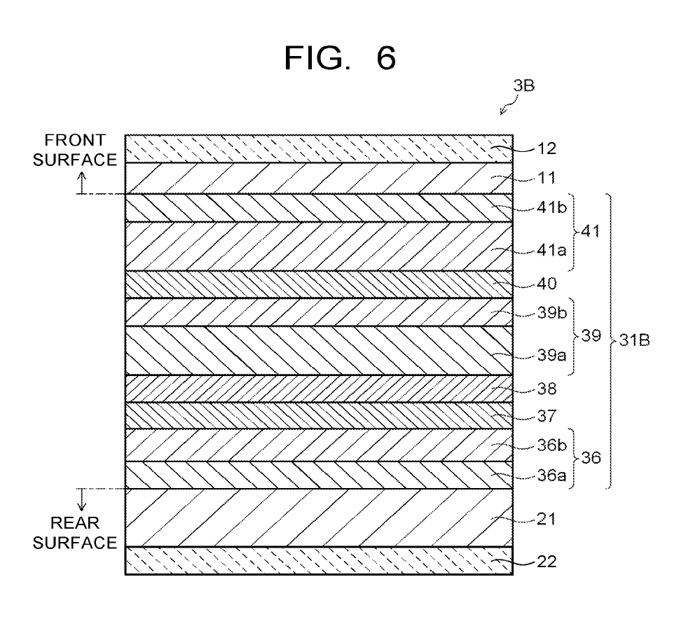

The stack 3 arranged in the electrolytic solution tank 2 has a flat plate shape spreading in a first direction and a second direction perpendicular thereto. The stack 3 is constituted, for example, by forming the photovoltaic layer 31 and the first electrode layer 11 on the second electrode layer 21 as a base member. Here, the stack 3 will be described with a light irradiation side regarded as a front surface (upper surface) and an opposite side to the light irradiation side regarded as a rear surface (lower surface). A concrete configuration example of the stack 3 will be described referring to FIG. 5 and FIG. 6. FIG. 5 illustrates a photovoltaic cell 3A using a silicon-based solar cell as the photovoltaic layer 31A. FIG. 6 illustrates a photovoltaic cell 3B using a compound semiconductor-based solar cell as the photovoltaic layer 31B. In each of the photovoltaic cells 3A, 3B illustrated in FIG. 5 and FIG. 6, the first electrode layer 11 side is the light irradiation side.

The stack (photovoltaic cell using the silicon-based solar cell) 3A illustrated in FIG. 5 will be described. The photovoltaic cell 3A illustrated in FIG. 5 is composed of the first catalyst layer 12, the first electrode layer 11, the photovoltaic layer 31A, the second electrode layer 21, and the second catalyst layer 22. The second electrode layer 21 has a conductive property. As the forming material of the second electrode layer 21, a metal such as Cu, Al, Ti, Ni, Fe, Ag or the like, an alloy containing at least one of the metals, a conductive resin, a semiconductor such as Si, Ge or the like is used. The second electrode layer 21 also has a function as a support base member and thus maintains the mechanical strength of the photovoltaic cell 3A. The second electrode layer 21 is composed of a metal plate, an alloy plate, a resin plate, and a semiconductor substrate which are made of the above-described material. The second electrode layer 21 may be composed of an ion exchange membrane.

The photovoltaic layer 31A is formed on the front surface (upper surface) of the second electrode layer 21. The photovoltaic layer 31A is composed of a reflection layer 32, a first photovoltaic layer 33, a second photovoltaic layer 34, and a third photovoltaic layer 35. The reflection layer 32 is formed on the second electrode layer 21 and has a first reflection layer 32a and a second reflection layer 32b formed in order from the lower side. As the first reflection layer 32a, a metal such as Ag, Au, Al, Cu or the like having a light-reflection property and a conductive property, an alloy containing at least one of the metals or the like is used. The second reflection layer 32b is provided to enhance the light-reflection property by adjusting an optical distance. The second reflection layer 32b is to be joined with a later-described n-type semiconductor layer of the photovoltaic layer 31 and is thus preferably formed of a material having light-transmission property and capable of ohmic contact with the n-type semiconductor layer. As the second reflection layer 32b, a transparent conductive oxide such as ITO (indium tin oxide), zinc oxide (ZnO), FTO (fluorine-doped tin oxide), AZO (aluminum-doped tin oxide), ATO (antimony-doped tin oxide) or the like is used.

Each of the first photovoltaic layer 33, the second photovoltaic layer 34, and the third photovoltaic layer 35 is a solar cell using a pin-junction semiconductor. The photovoltaic layers 33, 34, 35 are different in absorption wavelength of light. Stacking them in a plane state makes it possible to absorb light in a wide range of wavelength of sunlight by the photovoltaic layer 31A and efficiently utilize the energy of sunlight. The photovoltaic layers 33, 34, 35 are connected in series, and can obtain a high open-circuit voltage.

The first photovoltaic layer 33 is formed on the reflection layer 32 and has an n-type amorphous-silicon (a-Si) layer 33a, an intrinsic amorphous silicon germanium (a-SiGe) layer 33b, and a p-type microcrystalline silicon (mc-Si) layer 33c formed in order from the lower side. The a-SiGe layer 33b absorbs light in a long wavelength region of about 700 nm. In the first photovoltaic layer 33, charge separation is caused by the light energy in the long wavelength region.

The second photovoltaic layer 34 is formed on the first photovoltaic layer 33 and has an n-type a-Si layer 34a, an intrinsic a-SiGe layer 34b, and a p-type mc-Si layer 34c formed in order from the lower side. The a-SiGe layer 34b absorbs light in an intermediate wavelength region of about 600 nm. In the second photovoltaic layer 34, charge separation is caused by the light energy in the intermediate wavelength region.

The third photovoltaic layer 35 is formed on the second photovoltaic layer 34 and has an n-type a-Si layer 35a, an intrinsic a-Si layer 35b, and a p-type mc-Si layer 35c formed in order from the lower side. The a-Si layer 35b absorbs light in a short wavelength region of about 400 nm. In the third photovoltaic layer 35, charge separation is caused by the light energy in the short wavelength region.

The first electrode layer 11 is formed on the p-type semiconductor (p-type mc-Si layer 35c) of the photovoltaic layer 31. The first electrode layer 11 is preferably formed of a material capable of ohmic contact with the p-type semiconductor layer. As the first electrode layer 11, a metal such as Ag, Au, Al, Cu or the like, an alloy containing at least one of the metals, a transparent conductive oxide such as ITO, ZnO, FTO, AZO, ATO or the like is used. The first electrode layer 11 may have, for example, a structure in which the metal and the transparent conductive oxide are layered, a structure in which the metal and another conductive material are combined, a structure in which the transparent conductive oxide and another conductive material are combined or the like.

In the photovoltaic cell 3A illustrated in FIG. 5, irradiation light passes through the first electrode layer 11 and reaches the photovoltaic layer 31A. The first electrode layer 11 arranged on the light irradiation side (the upper side in FIG. 5) has light-transmission property with respect to the irradiation light. The light-transmission property of the first electrode layer 11 on the light irradiation side is preferably 10% or more of the irradiation amount of the irradiation light, and more preferably 30% or more. The first electrode layer 11 may have an aperture through which the light is transmitted. The aperture ratio in this case is preferably 10% or more, and more preferably 30% or more. Further, to enhance the conductive property while maintaining the light-transmission property, a collector electrode in a linear shape, a lattice shape, a honeycomb shape or the like may be provided on at least a part of the first electrode layer 11 on the light irradiation side.

In the photovoltaic layer 31A of the photovoltaic cell 3A illustrated in FIG. 5, charge separation is caused by the light energy in each wavelength region of the irradiation light (sunlight or the like). In the photovoltaic cell 3A using the silicon-based solar cell as the photovoltaic layer 31A, holes are separated to the first electrode layer (anode) 11 side (front surface side) and electrons are separated to the second electrode layer (cathode) 21 side (rear surface side) to cause electromotive force in the photovoltaic layer 31A. As will be described later in detail, an oxidation reaction of water (H₂O) is caused near the first electrode layer 11 to which the holes migrate, and a reduction reaction of carbon dioxide (CO₂)k is caused near the second electrode layer 21 to which the electrons migrate. In the photovoltaic cell 3A using the silicon-based solar cell, the first electrode layer 11 is an oxidation electrode and the second electrode layer 21 is a reduction electrode.

The first catalyst layer 12 formed on the first electrode layer 11 is provided to enhance the chemical reactivity (oxidation reactivity in FIG. 5) near the first electrode layer 11. The second catalyst layer 22 provided on the second electrode layer 21 is provided to enhance the chemical reactivity (reduction reactivity in FIG. 5) near the second electrode layer 21. Utilizing the accelerative effects of the oxidation and reduction reactions by the catalyst layers 12, 22 makes it possible to reduce the overvoltage of the oxidation and reduction reactions. Accordingly, the electromotive force generated in the photovoltaic layer 31A can be more effectively utilized.

In the photovoltaic cell 3A using the silicon semiconductor-based solar cell, a catalyst accelerating the oxidation reaction is used as the first catalyst layer 12. Near the first electrode layer 11, H₂O is oxidized to generate O₂ and H⁺. Therefore, the first catalyst layer 12 is composed of a material that decreases the activation energy for oxidizing H₂O. In other words, the first catalyst layer 12 is composed of a material that decreases the overvoltage when H₂O is oxidized to generate O₂ and H⁺. Examples of the material include binary system metal oxides such as manganese oxide (Mn—O), iridium oxide (Ir—O), nickel oxide (Ni—O), cobalt oxide (Co—O), iron oxide (Fe—O), tin oxide (Sn—O), indium oxide (In—O), ruthenium oxide (Ru—O) and the like, ternary system metal oxides such as Ni—Co—O, Ni—Fe—O, La—Co—O, Ni—La—O, Sr—Fe—O and the like, quaternary system metal oxides such as Pb—Ru—Ir—O, La—Sr—Co—O and the like, and metal complexes such as Ru complex, Fe complex and the like. The shape of the first catalyst layer 12 is not limited to a thin film shape but may be an island shape, a lattice shape, a grain shape, or a wire shape.

A material accelerating the reduction reaction is used as the second catalyst layer 22. Near the second electrode layer 21, CO₂ is reduced to produce a carbon compound (for example, CO, HCOOH, CH₄, CH₃OH, C₂H₅OH, C₂H₄ or the like). The second catalyst layer 22 is composed of a material that decreases the activation energy for reducing CO₂. In other words, the second catalyst layer 22 is composed of a material that decreases the overvoltage when CO₂ is reduced to produce the carbon compound. Examples of the material include metals such as Au, Ag, Cu, Pt, Pd, Ni, Zn and the like, an alloy containing at least one of the metals, carbon materials such as C, graphene, CNT (carbon nanotube), fullerene, Ketjen black and the like, and metal complexes such as Ru complex, Re complex and the like. The shape of the second catalyst layer 22 is not limited to a thin film shape but may be an island shape, a lattice shape, a grain shape, or a wire shape.

As a manufacturing method of the first catalyst layer 12 and the second catalyst layer 22, a thin film forming method such as a sputtering method, a vapor deposition method or the like, a coating method using a solution in which a catalyst material is dispersed, an electrodeposition method, a catalyst forming method by thermal processing or electrochemical processing of the first electrode layer 11 or the second electrode layer 21 itself can be used. The formation of the first catalyst layer 12 and the second catalyst layer 22 is optional, and therefore they may be formed when necessary. The photovoltaic cell 3A may have both or only one of the first catalyst layer 12 and the second catalyst layer 22.

The photovoltaic layer 31 has been described using the photovoltaic layer 31A having the stack structure of the three photovoltaic layers as an example in FIG. 5, but is not limited to this. The photovoltaic layer 31 may have a stack structure of two or four or more photovoltaic layers. In place of the photovoltaic layer 31 in the stack structure, one photovoltaic layer 31 may be used. The photovoltaic layer 31 is not limited to the solar cell using the pin-junction semiconductor but may be a solar cell using a pn-junction semiconductor. The semiconductor layer is not limited to Si or Ge, but may be composed of a compound semiconductor such as GaAs, GaInP, AlGaInP, CdTe, CuInGaSe, GaP, GaN or the like. For the semiconductor layer, various forms such as single crystal, polycrystal, amorphous and the like can be used. The first electrode layer 11 and the second electrode layer 21 may be provided entirely or partially on the photovoltaic layer 31.

The stack (photovoltaic cell using the compound semiconductor-based solar cell) 3B illustrated in FIG. 6 will be described. The photovoltaic cell 3B illustrated in FIG. 6 is composed of the first catalyst layer 12, the first electrode layer 11, the photovoltaic layer 31B, the second electrode layer 21, and the second catalyst layer 22. The photovoltaic layer 31B in the photovoltaic cell 3B is composed of a first photovoltaic layer 36, a buffer layer 37, a tunnel layer 38, a second photovoltaic layer 39, a tunnel layer 40, and a third photovoltaic layer 41.

The first photovoltaic layer 36 is formed on the second electrode layer 21 and has a p-type Ge layer 36a and an n-type Ge layer 36b formed in order from the lower side. On the first photovoltaic layer 36, the buffer layer 37 and the tunnel layer 38 containing GaInAs are formed for lattice matching and electrical connection with GaInAs used for the second photovoltaic layer 39. The second photovoltaic layer 39 is formed on the tunnel layer 38 and has a p-type GaInAs layer 39a and an n-type GaInAs layer 39b formed in order from the lower side. On the second photovoltaic layer 39, the tunnel layer 40 containing GaInP is formed for lattice matching and electrical connection with GaInP used for the third photovoltaic layer 41. The third photovoltaic layer 41 is formed on the tunnel layer 40 and has a p-type GaInP layer 41a and an n-type GaInP layer 41b formed in order from the lower side.

The photovoltaic layer 31B in the photovoltaic cell 3B illustrated in FIG. 6 is opposite in direction of stacking the p-type and n-type layers to the photovoltaic layer 31A in the photovoltaic cell 3A illustrated in FIG. 5 and is thus different in polarity of electromotive force thereto. When charge separation is caused in the photovoltaic layer 31B by the irradiation light, electrons are separated to the first electrode layer (cathode) 11 side (front surface side) and holes are separated to the second electrode layer (anode) 21 side (rear surface side). A reduction reaction of CO₂ is caused near the first electrode layer 11 to which the electrons migrate. An H₂O oxidation reaction is caused near the second electrode layer 21 to which the holes migrate. Accordingly, in the photovoltaic cell 3B using the compound semiconductor-based solar cell, the first electrode layer 11 is a reduction electrode and the second electrode layer 21 is an oxidation electrode.

The photovoltaic cell 3B illustrated in FIG. 6 is opposite in polarity of electromotive force and the oxidation and reduction reactions to the photovoltaic cell 3A illustrated in FIG. 5. Therefore, the first catalyst layer 12 is composed of a material accelerating the reduction reaction and the second catalyst layer 22 is composed of a material accelerating the oxidation reaction. With respect to the case of using the photovoltaic cell 3A illustrated in FIG. 5, the material of the first catalyst layer 12 and the material of the second catalyst layer 22 are changed with each other in the photovoltaic cell 3B. The polarity of the photovoltaic layer 31 and the materials of the first catalyst layer 12 and the second catalyst layer 22 are arbitrary. Since the oxidation and reduction reactions of the first catalyst layer 12 and the second catalyst layer 22 are decided depending on the polarity of the photovoltaic layer 31, the materials are selected according to the oxidation and reduction reactions.

One of the first and second electrolytic solutions 4, 5 is a solution containing H₂O and the other is a solution containing CO₂. In the case of employing the photovoltaic cell 3A illustrated in FIG. 5, the solution containing H₂O is used as the first electrolytic solution 4 and the solution containing CO₂ is used as the second electrolytic solution 5. In the case of employing the photovoltaic cell 3B illustrated in FIG. 6, the solution containing CO₂ is used as the first electrolytic solution 4 and the solution containing H₂O is used as the second electrolytic solution 5.

As the solution containing H₂O, a solution containing an arbitrary electrolyte is used. This solution is preferably a solution accelerating the oxidation reaction of H₂O. Examples of the solution containing an electrolyte include solutions containing phosphate ions (PO₄²), borate ions (BO₃³⁻), sodium ions (Na⁻), potassium ions (K⁺), calcium ions (Ca²⁺), lithium ions (Li⁺), cesium ions (Cs⁺), magnesium ions (Mg²⁻), chloride ions (Cl⁻), hydrogen carbonate ions (HCO₃⁻) and the like. 100471 The solution containing CO₂ is preferably a solution high in CO₂ absorption rate. Examples of the solution containing CO₂ include solutions such as LiHCO₃, NaHCO₃, KHCO₃, CsHCO₃ and the like as a solution containing H₂O. For the solution containing CO₂, alcohols such as methanol, ethanol, acetone and the like may be used. The solution containing H₂O and the solution containing CO₂ may be the same solution. Since the solution containing CO₂ is preferably high in CO₂ absorption amount, a solution different from the solution containing H₂O may be used. The solution containing CO₂ is desirably an electrolytic solution containing a CO₂ absorbent that decreases a reduction potential of CO₂, is high in ion conductivity, and absorbs CO₂.

Examples of the electrolytic solution include ionic liquids composed of salt of cations such as imidazolium ion, pyridinium ion and the like and anions such as BF₄⁻, PF₆⁻ and the like and are in a liquid state in a wide temperature range, and their solutions. Other examples of the electrolytic solution include amine solutions such as ethanolamine, imidazole, pyridine and the like and their solutions. Amine may be any of primary amine, secondary amine, and tertiary amine. Examples of the primary amine include methylamine, ethylamine, propylamine, butylamine, pentylamine, hexylamine and the like. The hydrocarbon of the amine may be replace with alcohol, halogen or the like. Examples of the amine whose hydrocarbon is replaced include methanolamine, ethanolamine, chloromethylamine and the like. Besides, an unsaturated bond may exist. Those hydrocarbons also apply to secondary amine and tertiary amine. Examples of the secondary amine include dimethylamine, diethylamine, dipropylamine, dibutylamine, dipentylamine, dihexylamine, dimethanolamine, diethanolamine, dipropanolamine and the like. The replaced hydrocarbons may be different. This also applies to tertiary amine. Examples of the amine with different hydrocarbon include methylethylamine, methylpropylamine and the like. Examples of the tertiary amine include trimethylamine, trihexylamine, tripropylamine, tributylamine, trihexylamine, trimethanolamine, triethanolamine, tripropanolamine, tributanolamine, trihexanolamine, methyldiethylamine, methyldipropylamine and the like. Examples of cation in the ionic liquid include 1-ethyl-3-methylimidazolium ion, 1-methyl-3-propylimidazolium ion, 1-butyl-3-methylimidazolium ion, 1-methyl-3-pentylimidazolium ion, 1-hexyl-3-methylimidazolium ion and the like. The position 2 of imidazolium ion may be replaced. Examples of the imidazolium ion whose position 2 is replaced include 1-ethyl-2,3-dimethylimidazolium ion, 1, 2-dimethyl-3-propylimidazolium ion, 1-butyl-2,3-dimethylimidazolium ion, 1, 2-dimethyl-3-pentylimidazolium ion, 1-hexyl-2,3-dimethylimidazolium ion and the like. Examples of pyridinium ion include methylpyridinium, ethylpyridinium, propylpyridinium, butylpyridinium, pentylpyridinium, hexylpyridinium and the like. In both of imidazolium ion and pyridinium ion, an alkyl group may be replaced and an unsaturated bond may exist. Examples of anion include fluoride ion, chloride ion, bromide ion, chloride ion, BF₄⁻, PF₆⁻, CF₃COO⁻, CF₃SO₃⁻, NO₃⁻, SCN⁻, (CF₃SO₂)3C⁻, bis(trifluoromethoxysulfonyl)imide, bis(perfluoroethylsulfonyl)imide and the like. Dipolar ion made by bonding the cation and the anion in the ionic liquid by hydrocarbon may be adoptable.

As illustrated in FIG. 2, in the second liquid chamber 2B of the electrolytic solution tank 2 in which the second electrolytic solution 5 is stored, a gas supply pipe 51 constituting the CO₂ supply unit 103 is provided. The gas supply pipe 51 is arranged to be immersed in the second electrolytic solution 5. FIG. 2 illustrates the configuration of the photoelectrochemical module 1 based on the polarity of the electromotive force of the photovoltaic cell 3A illustrated in FIG. 5. The gas supply pipe 51 is arranged in the second electrolytic solution 5 in which the second electrode layer 21 that is the reduction electrode is immersed. In the photoelectrochemical module 1 configured based on the polarity of the electromotive force of the photovoltaic cell 3B illustrated in FIG. 6, the gas supply pipe 51 is arranged in the first electrolytic solution 4 in which the first electrode layer 11 that is the reduction electrode is immersed. Hereafter, the configuration of the photoelectrochemical module 1 based on the polarity of the electromotive force of the photovoltaic cell 3A will be mainly described unless otherwise noted.

The CO₂ gas separated by removing the impurities such as sulfur oxide and so on in the impurity removal unit 102 is introduced into the gas supply pipe 51 of the CO₂ supply unit 103. The gas supply pipe 51 has a plurality of gas supply holes (through holes) 52. The CO₂ gas introduced into the gas supply pipe 51 is released into the second electrolytic solution 5 from the gas supply holes 52. Since the second electrolytic solution 5 is composed of the solution high in CO₂ absorption amount as described above, the CO₂ gas released into second electrolytic solution 5 from the gas supply holes 52 is absorbed by the second electrolytic solution 5. The CO₂ absorbed by the second electrolytic solution 5 is reduced by the oxidation and reduction reactions which will be described hereafter in detail.

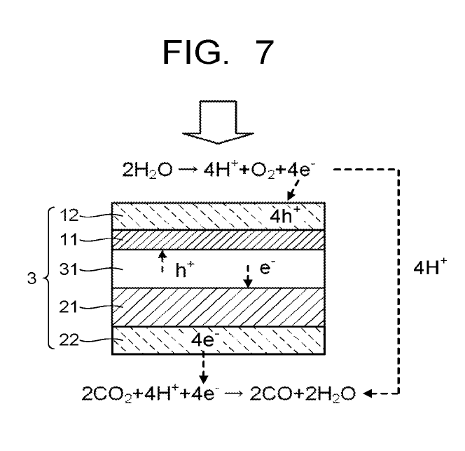

A principle of operation of the photoelectrochemical module 1 will be described referring to FIG. 7. Here, the operation will be described using, as an example, the polarity in the case of using the stack illustrated in FIG. 5, that is, the photovoltaic cell 3A using the silicon semiconductor-based solar cell as the photovoltaic layer 31A. The case where an absorbing liquid absorbing CO₂ is used as the second electrolytic solution 5 in which the second electrode layer 21 and the second catalyst layer 22 are to be immersed will be described. In the case of using the stack illustrated in FIG. 6, that is, the photovoltaic cell 3B using the compound semiconductor-based solar cell as the photovoltaic layer 31B, the polarity is reversed and therefore an absorbing liquid absorbing CO₂ is used as the first electrolytic solution 4.

As illustrated in FIG. 7, light irradiated from above (the first electrode layer 11 side of) the photoelectrochemical module 1 passes through the first catalyst layer 12 and the first electrode layer 11 and reaches the photovoltaic layer 31. Upon absorption of the light, the photovoltaic layer 31 generates electrons and holes paired therewith and separate them. In the photovoltaic layer 31, the electrons migrate to the n-type semiconductor layer side (the second electrode layer 21 side) and the holes generated as companions to the electrons migrate to the p-type semiconductor layer side (the first electrode layer 11 side). This charge separation causes electromotive force in the photovoltaic layer 31.

The holes generated in the photovoltaic layer 31 migrate to the first electrode layer 11 and combine with the electrons generated by the oxidation reaction caused near the first electrode layer 11 and the first catalyst layer 12. The electrons generated in the photovoltaic layer 31 migrate to the second electrode layer 21 and are used for the reduction reaction caused near the second electrode layer 21 and the second catalyst layer 22. Concretely, near the first electrode layer 11 and the first catalyst layer 12 in contact with the first electrolytic solution 4, the reaction of the following Expression (1) is caused. Near the second electrode layer 21 and the second catalyst layer 22 in contact with the second electrolytic solution 5, the reaction of the following Expression (2) is caused.

2H₂O→4H⁺+O₂+4e⁻ (1)

2CO₂+4H⁺+4e⁻→2CO+2H₂O (2)

Near the first electrode layer 11 and the first catalyst layer 12, H₂O contained in the first electrolytic solution 4 is oxidized (lose electrons) to generate O₂ and H⁺ as expressed in Expression (1). H⁺ generated on the first electrode layer 11 side migrates to the second electrode layer 21 side via the electrolytic solution flow path 6 (FIG. 2) provided in the electrolytic solution tank 2 as the ion migration pathway or the pores 8 (FIG. 3) provided in the stack 3. Near the second electrode layer 21 and the second catalyst layer 22, CO₂ supplied into the second electrolytic solution 5 from the gas supply pipe 51 is reduced (gains electrons) as expressed in Expression (2). Concretely, CO₂ in the second electrolytic solution 5, H⁺ migrated to the second electrode layer 21 side via the ion migration pathway and the electrons migrated to the second electrode layer 21 react to generate, for example, CO and H₂O.

The photovoltaic layer 31 needs to have an open-circuit voltage equal to or higher than a potential difference between a standard oxidation-reduction potential of the oxidation reaction caused near the first electrode layer 11 and a standard oxidation-reduction potential of the reduction reaction caused near the second electrode layer 21. For example, the standard oxidation-reduction potential of the oxidation reaction in Expression (1) is 1.23 V, and the standard oxidation-reduction potential of the reduction reaction in Expression (2) is −0.1 V. Therefore, the open-circuit voltage of the photovoltaic layer 31 needs to be 1.33 V or higher. The open-circuit voltage of the photovoltaic layer 31 is preferably equal to or higher than a potential difference including the overvoltage. Concretely, when each of the overvoltage of the oxidation reaction in Expression (1) and the reduction reaction in Expression (2) is 0.2 V, the open-circuit voltage is desirably 1.73 V or higher.

Near the second electrode layer 21, not only the reduction reaction from CO₂ to CO expressed in Expression (2) but also a reduction reaction from CO₂ to fonnic acid (HCOOH), methane (CH₄), ethylene (C₂H₄), methanol (CH₃OH), ethanol (C₂H₅OH) or the like can also be caused. A reduction reaction of H₂O used in the second electrolytic solution 5 can be further caused to generate H₂. By changing the moisture (H₂O) amount in the second electrolytic solution 5, a reducing substance of CO₂ to be produced can be changed. For example, it is possible to change a generation ratio of CO, HCOOH, CH₄, C₂H₄, CH₃OH, C₂H₅OH, H₂ and the like.

The photoelectrochemical module 1 in the photoelectrochemical reaction system 100 of the embodiment includes the ion migration pathway allowing ions to migrate between the first electrolytic solution 4 and the second electrolytic solution 5. The hydrogen ions (H⁺) generated on the first electrode layer 11 are sent to the second electrode layer 21 side via electrolytic solution flow path 6 or the pores 8 as the ion migration pathway. Efficiently sending the hydrogen ions (H⁺) generated on the first electrode layer 11 side to the second electrode layer 21 side accelerates the reduction reaction of CO₂ near the second electrode layer 21 and the second catalyst layer 22. The reduction efficiency of CO₂ by light can be enhanced. In other words, the photoelectrochemical reaction system 100 of this embodiment can efficiently decompose CO₂ by light energy, thereby making it possible to improve the conversion efficiency, for example, from sunlight to chemical energy.

The CO₂ supply unit 103 in the photoelectrochemical reaction system 100 of this embodiment utilizes the pressure (exhaust pressure) of the gas containing CO₂ (exhaust gas or the like) exhausted from the CO₂ generation unit 101 to supply the CO₂ gas into the second electrolytic solution 5 via the gas supply holes 52 of the gas supply pipe 51. For example, in the case of sending CO₂ to the electrolytic solution tank after being absorbed by the CO₂ absorbent, energy to send the CO₂ absorbent (absorbing liquid) to the electrolytic solution tank is required. Considering sending of the CO₂ absorbent absorbed CO₂ by a pump, energy to operate the pump is required. This decreases the energy efficiency as the whole photoelectrochemical system. In contrast, utilizing the exhaust pressure of the gas in the CO₂ generation unit 101 makes it possible to supply the CO₂ gas into the second electrolytic solution 5 without consuming energy for transfer.

Further, a gaseous product such as a carbon compound (for example, CO, CH₄, C₂H₄ or the like) and H₂ produced by reducing CO₂ and H₂O are sent from the electrolytic solution tank 2 of the CO₂ reduction unit 104 to the product collection unit 105 utilizing the pressure (exhaust pressure) of the CO₂ gas released from the gas supply pipe 51 into the second electrolytic solution 5. Therefore, the gaseous product can be accumulated in the product collection unit 105 without separately generating a transfer means for the gaseous product, that is, airflow or the like required for transfer of the gaseous product. These can enhance the energy efficiency as the photoelectrochemical reaction system 100. Consequently, it becomes possible to provide the photoelectrochemical reaction system 100 high in CO₂ decomposition efficiency and excellent in energy efficiency as the whole system.

In the photoelectrochemical reaction system 100 of the embodiment, the ion migration pathway allowing ions to move between the first electrolytic solution 4 and the second electrolytic solution 5 is not limited to the electrolytic solution flow path 6 provided in the electrolytic solution tank 2 and the pores 8 provided in the photovoltaic cell (stack) 3. For example, an ion migration pathway may be provided in the base plate (second electrode layer 21) that substantially divides the electrolytic solution tank 2 into two chambers, or the photovoltaic cell 3 may be divided into a plurality portions and an ion migration pathway may be provided between them. The structure of the photoelectrochemical module 1 is not limited to the structures illustrated in FIG. 2 and FIG. 3. For example, a photoelectrochemical module lA having a structure in which a photovoltaic cell 3 formed in a tubular shape and a tubular electrolytic solution tank 2 are arranged in order around a gas supply pipe 51 as illustrated in FIG. 4, may be employed.

The photoelectrochemical module 1A illustrated in FIG. 4 has a structure in which the gas supply pipe 51, the photovoltaic cell 3 formed in a tubular shape, and the tubular electrolytic solution tank 2 are concentrically arranged for instance. The tubular electrolytic solution tank 2 is composed of a material having a light-transmission property so as to allow light to reach the photovoltaic cell 3 arranged therein. The tubular photovoltaic cell 3 has a structure in which layers are stacked to have a circular cross-sectional shape such that the first electrode layer 11 that is on the light irradiation side is located on an outer side. A plurality of electrolytic solution flow paths 6 are provided and their shape is not limited a circle but may be an ellipse, a triangle, a square, a slit shape or the like. Between the tubular photovoltaic cell 3 and the tubular electrolytic solution tank 2, the first liquid chamber 2A in which the first electrolytic solution 4 is filled is formed. Between the gas supply pipe 51 and the tubular photovoltaic cell 3, the second liquid chamber 2B in which the second electrolytic solution 5 is filled is formed. The outside diameters and inside diameters of the gas supply pipe 51, the tubular photovoltaic cell 3, and the electrolytic solution tank 2 are adjusted so that the first liquid chamber 2A and the second liquid chamber 2B are formed.

In the photoelectrochemical module lA illustrated in FIG. 4, the tubular photovoltaic cell 3 is arranged around the gas supply pipe 51 via the second electrolytic solution 5. Therefore, feeding the CO₂ gas through gas supply pipe 51 makes it possible to efficiently release the CO₂ gas from the gas supply holes 52 into the second electrolytic solution 5. Further, it is also possible to allow the gaseous product such as the carbon compound (for example, CO, CH₄, C₂H₄ or the like) and H₂ produced by reducing CO₂ and H₂O to flow along the direction of a tube axis of the tubular photovoltaic cell 3 utilizing the exhaust pressure of the CO₂ gas. Accordingly, transfer of the gaseous product is facilitated. It is also possible to allow O₂ generated by the oxidation reaction in the first liquid chamber 2A to flow along the direction of a tube axis of the electrolytic solution tank 2, thus also facilitating transfer of O₂.

In the photoelectrochemical reaction system 100 illustrated in FIG. 1, the carbon compound produced by the reduction reaction in the CO₂ reduction unit 104 is collected to a tank or the like as the product collection unit 105. The carbon compound produced in the CO₂ reduction unit 104 may be supplied as a carbon fuel to a combustion furnace of the CO₂ generation unit 101 of for example, a power plant, iron factory, chemical factory, disposal center or the like. O₂ generated by the oxidation reaction in the CO₂ reduction unit 104 may be similarly collected to a tank or the like, or may be supplied to the combustion furnace as a combustion improver. In addition to the above, O₂ can be utilized for various uses such as supply to a breeding pond so as to promote growth of living things, supply to a sewage disposal plant for improvement in processing efficiency by bacteria, supply to an air purification system, water clarification system and the like.

### Second Embodiment

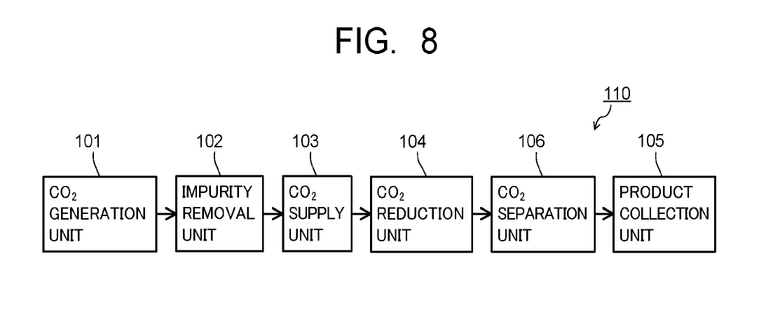

FIG. 8 is a configuration diagram of a photoelectrochemical reaction system according to a second embodiment. A photoelectrochemical reaction system 110 of the second embodiment includes a CO₂ generation unit 101, an impurity removal unit 102, a CO₂ supply unit 103, a CO₂ reduction unit 104, a CO₂ separation unit 106, and a product collection unit 105. The constitutional units 101, 102, 103, 104, 105 other than the CO₂ separation unit 106 have the same configurations as those in the photoelectrochemical reaction system 100 of the first embodiment.

In the photoelectrochemical module 1 constituting the CO₂ reduction unit 104, the carbon compound and hydrogen produced by the reduction reaction of CO₂ and H₂O are collected to a tank or the like as the product collection unit 105. There is a possibility that CO₂ which has not been decomposed is mixed in the produced carbon compound and hydrogen. In the photoelectrochemical reaction system 110 of the second embodiment, the CO₂ separation unit 106 is provided between the CO₂ reduction unit 104 and the product collection unit 105. To the CO₂ separation unit 106, for example, a molecular sieve using a polymeric film, zeolite, a carbon film, CO₂ absorbent using amine, KOH or NaOH solution, and the like, is applicable. Separation of CO₂ from the produced carbon product enables enhancement of the utility value of the product. The CO₂ gas separated from the product may be returned to the CO₂ reduction unit 104 or may be sent to a CO₂ absorption unit as illustrated in the third embodiment.

### Third Embodiment

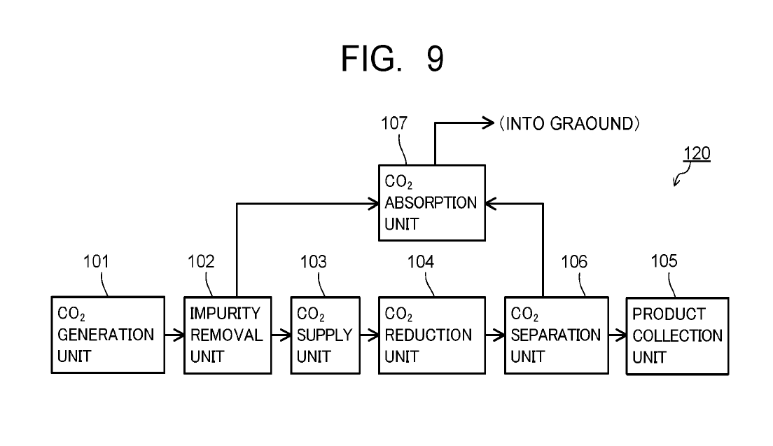

FIG. 9 is a configuration diagram of a photoelectrochemical reaction system according to a third embodiment. A photoelectrochemical reaction system 120 of the third embodiment includes a CO₂ generation unit 101, an impurity removal unit 102, a CO₂ supply unit 103, a CO₂ reduction unit 104, a CO₂ separation unit 106, a product collection unit 105, and a CO₂ absorption unit 107. The constitutional units 101, 102, 103, 104, 106, 105 other than the CO₂ absorption unit 107 have the same configurations as those in the photoelectrochemical reaction systems 100, 110 of the first and second embodiments.

The CO₂ absorption unit 107 is, for example, a CCS (Carbon Dioxide Capture and Storage). In the CO₂ absorption unit 107, a part of CO₂ separated in the impurity removal unit 102 and/or CO₂ separated from the product in the CO₂ separation unit 106 is absorbed by a CO₂ absorbent. Concrete examples of the CO₂ absorbent are as described above. By heating the CO₂ absorbent absorbed CO₂, CO₂ is separated. The separated CO₂ is stored underground or the like. By using both the CO₂ reduction unit 104 (CCU: Carbon dioxide Capture and Utilization) and the CO₂ absorption unit 107 (CCS: Carbon dioxide Capture and Storage), the CO₂ gas generated in the CO₂ generation unit 101 can be decomposed or stored without being released into the atmosphere.

Note that the configurations of the first to third embodiments are applicable in combination and partially replaced. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A photoelectrochemical reaction system, comprising:
a CO₂ generation unit generating gas containing carbon dioxide;
a CO₂ reduction unit comprising: a stack including an oxidization electrode layer oxidizing water, a reduction electrode layer reducing carbon dioxide, and a photovoltaic layer provided between the oxidization electrode layer and the reduction electrode layer, and performing a charge separation by light energy; an electrolytic solution tank storing a first electrolytic solution in which the oxidization electrode layer is immersed and a second electrolytic solution in which the reduction electrode layer is immersed; and an ion migration pathway allowing ions to migrate between the first electrolytic solution and the second electrolytic solution; and
a CO₂ supply unit comprising a gas supply pipe supplying the gas generated in the CO₂ generation unit into the second electrolytic solution.

2. The system of claim 1, wherein the gas supply pipe is immersed in the second electrolytic solution, and has a gas supply hole which releases the gas introduced from the CO₂ generation unit into the second electrolytic solution.

3. The system of claim 1, wherein the CO₂ supply unit supplies the gas exhausted from the CO₂ generation unit into the second electrolytic solution by an exhaust pressure of the gas.

4. The system of claim 1, wherein the stack further comprises an oxidation catalyst layer provided on the oxidization electrode layer and a reduction catalyst layer provided on the reduction electrode layer.

5. The system of claim 1, wherein the CO₂ reduction unit reduces the carbon dioxide to generate a carbon compound and oxidizes water to generate oxygen and hydrogen ions.

6. The system of claim 5, further comprising:
a product collection unit collecting the carbon compound generated in the CO₂ reduction unit.

7. The system of claim 6, wherein the carbon compound generated in the CO₂ reduction unit is sent from the CO₂ reduction unit to the product collection unit by a pressure of the gas released from the gas supply pipe.

8. The system of claim 6, further comprising
a CO₂ separation unit separating carbon dioxide from the carbon compound generated in the CO₂ reduction unit.

9. The system of claim 8, further comprising:
an impurity removal unit removing an impurity from the gas exhausted from the CO₂ generation unit,
wherein the CO₂ supply unit supplies the gas from which the impurity has been removed in the impurity removal unit, into the second electrolytic solution.

10. The system of claim 9, further comprising
a CO₂ absorption unit absorbing at least one of the gas from which the impurity has been removed in the impurity removal unit and the carbon dioxide gas separated from the carbon compound in the CO₂ separation unit.

11. The system of claim 1, wherein the CO₂ reduction unit reduces water together with the carbon dioxide to generate a mixture of a carbon compound and hydrogen, and oxidizes water to generate oxygen and hydrogen ions.

12. The system of claim 11, further comprising:
an impurity removal unit removing an impurity from the gas exhausted from the CO₂ generation unit;
a CO₂ separation unit separating carbon dioxide from the mixture of the carbon compound and hydrogen generated in the CO₂ reduction unit;
a product collection unit collecting the mixture of the carbon compound and hydrogen produced in the CO₂ reduction unit; and
a CO₂ absorption unit absorbing at least one of the gas from which the impurity has been removed in the impurity removal unit and the carbon dioxide gas separated from the carbon compound in the CO₂ separation unit.

13. The system of claim 1, wherein the photovoltaic layer has at least one of a pin-junction semiconductor and a pn-junction semiconductor.

14. The system of claim 1, wherein the CO₂ reduction unit comprises the stack in a tubular shape arranged around the gas supply pipe and the electrolytic solution tank in a tubular shape arranged around the stack in the tubular shape.

15. A photoelectrochemical reaction system, comprising:
a CO₂ generation unit generating gas containing carbon dioxide;
a CO₂ reduction unit comprising: a stack including an oxidization electrode layer oxidizing water, a reduction electrode layer reducing carbon dioxide, and a photovoltaic layer provided between the oxidization electrode layer and the reduction electrode layer, and performing a charge separation by light energy; an electrolytic solution tank storing a first electrolytic solution in which the oxidization electrode layer is immersed and a second electrolytic solution in which the reduction electrode layer is immersed; and an ion migration pathway allowing ions to migrate between the first electrolytic solution and the second electrolytic solution, the CO₂ reduction unit reducing the carbon dioxide to generate a carbon compound and oxidizing water to generate oxygen and hydrogen ions;
a CO₂ supply unit comprising a gas supply pipe supplying the gas generated in the CO₂ generation unit into the second electrolytic solution; and
a product collection unit collecting the carbon compound generated in the CO₂ reduction unit,
wherein the carbon compound generated in the CO₂ reduction unit is sent from the CO₂ reduction unit to the product collection unit by a pressure of the gas containing the carbon dioxide released from the gas supply pipe.
